(19) United States
(12) Patent Application Publication
(10) Pub. No.: US 2005/0144539 A1
(43) Pub. Date: Jun. 30, 2005

(54) Semiconductor device capable of preventing malfunction resulting from false signal generated in level shift circuit

(75) Inventor: Shoichi Orita, Tokyo (JP)

Correspondence Address: MCDERMOTT, WILL & EMERY, 600 13th Street, N.W., WASHINGTON, DC, 20005-3096, US

(73) Assignee: MITSUBISHI DENKI KABUSHIKI KAISHA

(21) Appl. No.: 10/895,836

(22) Filed: Jul. 22, 2004

(30) Foreign Application Priority Data
Dec. 15, 2003 (JP) JP2003-416164

(51) Int. Cl. G06F 11/00

(52) U.S. Cl. 714/48

(57) ABSTRACT

A false signal detection circuit is connected in parallel to a level shift circuit. The false signal detection circuit has the same configuration as those of on-level shift and off-level shift circuits in the level shift circuit, except that an HVMOS is a dummy switching device. Voltage drop developed in a false signal detecting resistor is sent as a false signal indication signal indicating generation of a false signal in the level shift circuit through a NOT gate to a malfunction prevention circuit. In response to the input of the false signal indication signal, the malfunction prevention circuit performs predetermined processing for malfunction prevention.

### BACKGROUND OF THE INVENTION

1. Field of the Invention

The present invention relates to a semiconductor device and more particularly, to a technique for preventing a malfunction as a result of a false signal generated in a level shift circuit.

2. Description of the Background Art

A power semiconductor element such as an MOSFET or an IGBT constituting a power semiconductor device is actuated by a high voltage integrated circuit (hereinafter referred to as an “HVIC”). As an example, when two power semiconductor elements of upper and lower arms constituting a half bridge inverter are to be actuated, an HVIC comprising two drive circuits is used including a high-side (high-potential island) drive circuit for driving the power semiconductor element of the upper arm, and a low-side drive circuit for driving the power semiconductor element of the lower arm. Such an HVIC comprises a so-called level shift circuit for transmitting a drive signal to the high-side drive circuit. A level shift circuit generally used includes a high voltage MOSFET (hereinafter referred to as a “HVMOS”) actuated by a drive signal, and a level shift resistor connected in series to the HVMOS. Voltage drop developed in the level shift resistor is transmitted as a high-side drive signal.

In many cases, the half bridge inverter actuated by the HVIC uses an inductive (L) load such as a motor or a fluorescent lamp. The inverter also includes a parasitic inductance in an interconnection on a printed circuit board. In a switching period of the half bridge inverter, and particularly, when the power semiconductor element of the lower arm is to be turned on, these inductances cause the midpoint potential of the half bridge connection, namely, a high-side reference potential VS of the HVIC (potential VS in FIG. 1), to make temporary transition to a negative side with respect to a potential GND (a substrate potential, namely, lowest potential of the HVIC). When the half bridge inverter is connected through the L load to a two-phase or three-phase inverter circuit, switching of these inverters of different phases also causes temporary transition of the high-side reference potential VS to the negative side. In the following, such transition of the high-side reference potential VS to the negative side will be referred to as a “negative noise”.

The negative noise of the high-side reference potential VS at a high level causes the following problem. That is, transition of the high-side reference potential VS to the negative side causes a high-side power supply potential VB (potential VB in FIG. 1) to make a transition to the negative side with respect to the potential GND. This causes a parasitic diode between the high side and the ground and a parasitic diode between the drain and source of the HVMOS to be turned on, whereby flow of a large current occurs from the substrate of the HVIC to the power supply of the high side. Recovery of the high-side reference potential VS is accompanied by a recovery current as a result of turn-off of the parasitic diodes. Specifically, the recovery current in the parasitic diode of the HVMOS flows through the level shift resistor, thereby causing voltage drop in the level shift resistor. The high side of the HVIC mistakenly recognizes this voltage drop as a drive signal for the high side, leading to a malfunction of the high-side drive circuit. As a result, the power semiconductor element of the upper arm is unnecessarily turned on, causing a problem such as a short circuit between the arms.

Such a malfunction may also result from a change in voltage dv/dt applied to the midpoint. When a parasitic capacitance Cp existing between the drain and source of the HVMOS of the level shift circuit connected to the high side of the HVIC experiences the change in voltage dv/dt applied from outside, the parasitic capacitance Cp is subjected to flow of a current Ip calculated by the formula:
Ip=Cp×dv/dt
The current Ip further flows into the level shift resistor, whereby voltage drop is developed in the level shift resistor. The high side of the HVIC mistakenly recognizes this voltage drop as a drive signal for the high side, thus causing the same problem as discussed above. In response, a CR filter is generally used to discriminate between a drive signal and a false signal.

In many cases, a drive signal in the HVIC includes an on pulse signal and an off pulse signal for respectively turning on and off a power semiconductor element. In this case, the level shift circuit includes a level shift circuit for on pulse signal transmission (on-level shift circuit) and a level shift circuit for off pulse signal transmission (off-level shift circuit). The foregoing recovery current and the current generated by the change in voltage dv/dt flow into each HVMOS of the on-level shift and off-level shift circuits, theoretically generating false signals in the on-level shift and off-level shift circuits in a concurrent manner. That is, elimination of signals concurrently sent from the on-level shift and off-level shift circuits results in removal of false signals, to thereby prevent a malfunction. A logic circuit using a logic filter system has been suggested which serves to prevent concurrent input of on and off pulse signals to an RS flip-flop for transmitting a drive signal to the high-side drive circuit, an exemplary technique of which is introduced in Japanese Patent Application Laid-Open No. 2001-145370.

The present inventor have noted the difference in current waveform between the recovery current after generation of the negative noise and the current generated by the normal drive signal, and have suggested discrimination between a drive signal and a false signal by means of provision of a passive circuit having two types of threshold values in the level shift circuit. An example of such a technique is introduced in Japanese Patent Application Laid-Open No. 2003-133927.

While a CR filter generally employed serves for removal of a false signal of a high-frequency component, it has difficulty in removing a false signal of a low-frequency component. In response, the CR may have a lowered cut-off frequency, which in turn causes a problem such as delay in transmitting a normal drive signal.

When the on-level shift and off-level shift circuits have different parasitic capacitances Cp of the HVMOS's, false signals generated in the on-level shift and off-level shift circuits do not temporally coincide with each other. As a result, the logic filter system introduced in Japanese Patent Application Laid-Open No. 2001-145370 may be unable to completely remove the false signals. Design change in the HVMOS or change in resistance of the level shift resistor in the level shift circuit to control detection sensitivity of the false signal may be responsive to this problem, which changes in turn adversely affect the normal operation of the level shift circuit. The logic filter system introduced in Japanese Patent Application Laid-Open No. 2001-145370 requires two level shift circuits including on-level shift and off-level shift circuits as a precondition and hence, is not applicable to the case in which a single level shift circuit is used to transmit both the on and off pulse signals.

According to the system introduced in Japanese Patent Application Laid-Open No. 2003-133927, a level shift resistor is split into two resistive elements to cause resistance increase of the level shift resistor. This causes a lowered margin of malfunction in the normal operation.

### SUMMARY OF THE INVENTION

It is therefore an object of the present invention to provide a semiconductor device allowing malfunction prevention while causing no effect on the normal operation of a level shift circuit, which malfunction results from a false signal generated in the level shift circuit.

According to the present invention, the semiconductor device includes a level shift circuit, a false signal detection circuit, and a malfunction prevention circuit. The level shift circuit converts a first signal to a second signal capable of being transmitted to a target circuit in a high side. The false signal detection circuit detects generation of a false signal in the level shift circuit, to output a false signal indication signal indicating generation of the false signal. The malfunction prevention circuit receives the second signal and the false signal indication signal. The malfunction prevention circuit serves to transmit the second signal to the target circuit. The malfunction prevention circuit further serves to recognize the second signal as a false signal to stop transmission of at least part of the second signal to the target circuit while being subjected to the input of the false signal indication signal, to thereby prevent a malfunction. The level shift circuit includes a series connection of a first resistor and a first switching device receiving the first signal. The level shift circuit outputs voltage drop developed in the first resistor as the second signal. The false signal detection circuit is connected in parallel to the level shift circuit. The false signal detection circuit includes a series connection of a second resistor and a second switching device fixed to a nonconductive state in normal operation. The false signal detection circuit outputs voltage drop developed in the second resistor as the false signal indication signal.

When the second switching device is equivalent to the first switching device, for example, output of the false signal indication signal from the false signal detection circuit can be concurrent with generation of a false signal resulting from a parasitic diode or a parasitic capacitance of the first switching device. As a result, an accurate operation of the malfunction prevention circuit is provided, resulting in enhanced operational reliability. The malfunction prevention circuit is a separate circuit from the level shift circuit and hence, detection sensitivity of a malfunction can be controlled while causing no effect on the normal operation of the level shift circuit.

These and other objects, features, aspects and advantages of the present invention will become more apparent from the following detailed description of the present invention when taken in conjunction with the accompanying drawings.

### BRIEF DESCRIPTION OF THE DRAWINGS

FIGS. 1 and 2 both show the configuration of a semiconductor device according to a first preferred embodiment of the present invention;

FIG. 3 shows the configuration of a malfunction prevention circuit according to the first preferred embodiment;

FIG. 4 shows the configuration of a semiconductor device according to a second preferred embodiment of the present invention;

FIG. 5 shows the configuration of a malfunction prevention circuit according to a third preferred embodiment of the present invention;

FIG. 6 shows the configuration of a malfunction prevention circuit according to a fourth preferred embodiment of the present invention;

FIG. 7 shows the configuration of a malfunction prevention circuit according to a fifth preferred embodiment of the present invention;

FIG. 8 shows a modification of the malfunction prevention circuit according to the fifth preferred embodiment;

FIG. 9 shows the configuration of a semiconductor device according to a sixth preferred embodiment of the present invention;

FIG. 10 shows the configuration of a malfunction prevention circuit according to the sixth preferred embodiment; and

FIG. 11 shows the configuration of a semiconductor device according to a seventh preferred embodiment of the present invention.

### DESCRIPTION OF THE PREFERRED EMBODIMENTS

### First Preferred Embodiment

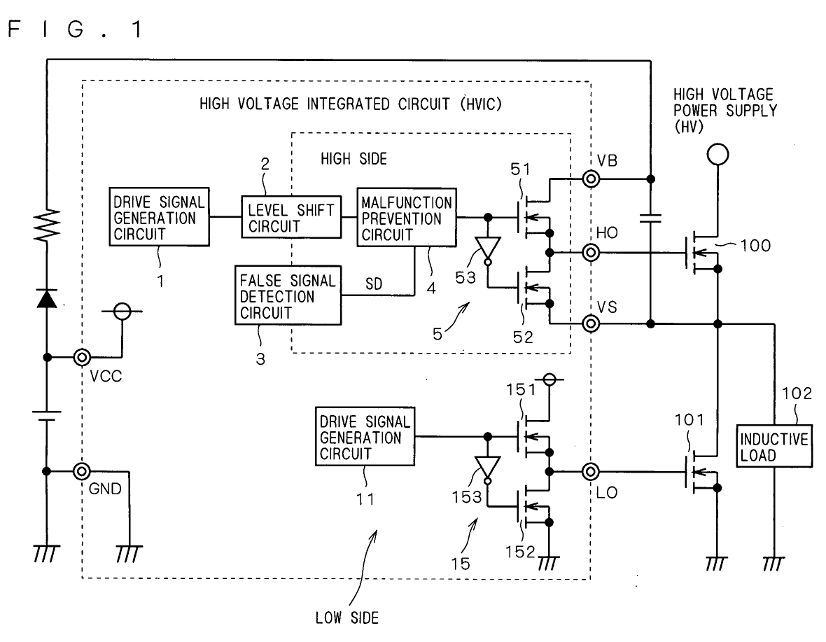

FIG. 1 shows a semiconductor device according to a first preferred embodiment of the present invention, which is a bootstrap-type power device driver using a high voltage integrated circuit (HVIC). The HVIC serves to actuate power semiconductor elements 100 and 101 such as MOSFETs or IGBTs interposed in half bridge connection between a high voltage power supply HV and the ground. The power semiconductor element 101 of the lower arm is connected to an inductive (L) load 102 such as a motor or a fluorescent lamp.

The HVIC comprises a drive signal generation circuit 1 for generating a drive signal (including on and off pulse signals) as a first signal for actuating the power semiconductor element 100 of the upper arm. This drive signal is sent to a level shift circuit 2 for conversion (level shifting) to a second signal which can be transmitted to each circuit in a high side. A false signal detection circuit 3 detects generation of a false signal at the level shift circuit 2, and outputs a false signal indication signal SD to a malfunction prevention circuit 4 during generation of the false signal. The malfunction prevention circuit 4 sends the drive signal after being subjected to level shifting at the level shift circuit 2 to a drive circuit (target circuit) 5. When the false signal indication signal SD is sent from the false signal detection circuit 3, the malfunction prevention circuit 4 recognizes the signal sent from the level shift circuit 2 as a false signal, and stops transmission thereof to the drive circuit 5. With reference to FIG. 1, the drive circuit 5 includes MOS transistors 51 and 52, and a NOT gate 53. In response to the signal sent from the malfunction prevention circuit 4, the drive circuit 5 serves to actuate the power semiconductor element 100. The false signal generated in the level shift circuit 2 is not sent to the drive circuit 5, and hence, this false signal does not cause malfunction of the power semiconductor element 100.

A drive signal generation circuit 11 serves to generate a drive signal for actuating the power semiconductor element 101 of the lower arm. The generated drive signal is directly sent to a drive circuit 15. With reference to FIG. 1, the drive circuit 15 includes MOS transistors 151 and 152, and a NOT gate 153. In response to the drive signal sent from the drive signal generation circuit 11, the drive circuit 15 serves to actuate the power semiconductor element 101.

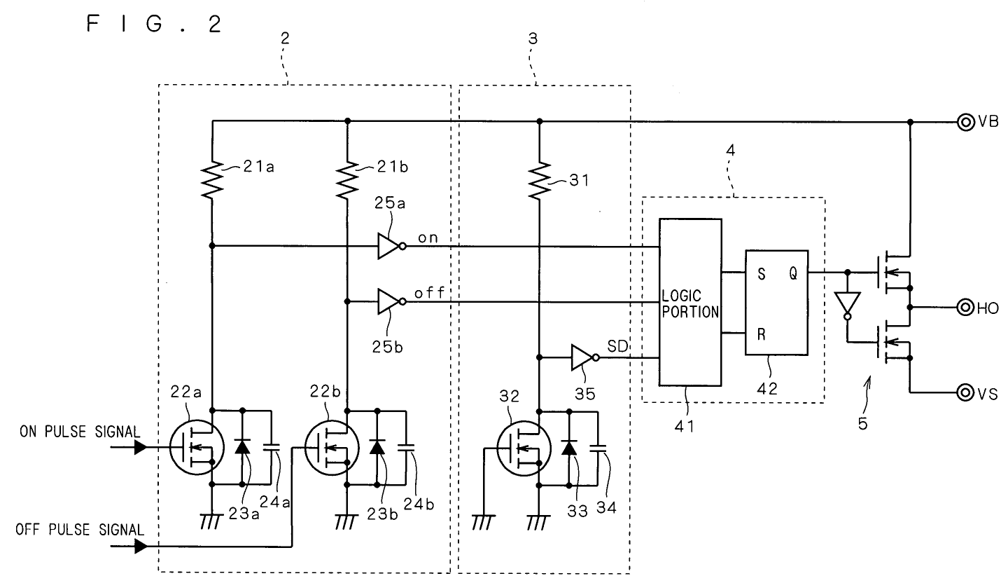

In the semiconductor device shown in FIG. 1, the configuration shown in FIG. 2 is responsible for the process in the HVIC from the input to the level shift circuit 2 to the output from the high side. In the first preferred embodiment, the drive signal generation circuit 1 shown in FIG. 1 serves to separately output as a drive signal the on and off pulse signals for respectively bringing the power semiconductor element 100 to an on state (conductive state) and to an off state. The level shift circuit 2 includes an on-level shift circuit and an off-level shift circuit for respectively receiving the on and off pulse signals.

The on-level shift circuit includes a series connection of a level shift resistor 21a and an HVMOS 22a as a first switching device, and a NOT gate 25a connected to one end of the level shift resistor 21a. Reference numerals 23a and 24a in FIG. 2 respectively represent a parasitic diode and a parasitic capacitance inherent in the HVMOS 22a. The HVMOS 22a has a gate receiving the on pulse signal, a source connected to a ground potential GND, and a drain connected through the level shift resistor 21a to a high-side power supply potential VB. The HVMOS 22a is switched on and off in response to the on pulse signal (first signal). Voltage drop thereby developed in the level shift resistor 21a is taken as an on signal for the high side (second signal), which signal is thereafter sent through the NOT gate 25a as a buffer to the malfunction prevention circuit 4.

The off-level shift circuit includes a series connection of a level shift resistor 21b and an HVMOS 22b as the first switching device, and a NOT gate 25b connected to one end of the level shift resistor 21b. Reference numerals 23b and 24b in FIG. 2 respectively represent a parasitic diode and a parasitic capacitance inherent in the HVMOS 22b. The HVMOS 22b has a gate receiving the off pulse signal, a source connected to the ground potential GND, and a drain connected through the level shift resistor 21b to the high-side power supply potential VB. The HVMOS 22b is switched on and off in response to the off pulse signal (first signal). Voltage drop thereby developed in the level shift resistor 21b is taken as an off signal for the high side (second signal), which signal is thereafter sent through the NOT gate 25b to the malfunction prevention circuit 4.

The false signal detection circuit 3 includes a series connection of a false signal detecting resistor 31 and an HVMOS 32 as a second switching device, and a NOT gate 35 connected to one end of the false signal detecting resistor 31. Reference numerals 33 and 34 in FIG. 2 respectively represent a parasitic diode and a parasitic capacitance inherent in the HVMOS 32. The HVMOS 32 has a gate and a source both connected to the ground potential GND, and a drain connected through the false signal detecting resistor 31 to the high-side power supply potential VB. That is, the HVMOS 32 is a dummy switching device fixed to an off state (nonconductive state) in the normal operation whose gate receives no drive signal. Voltage drop developed in the false signal detecting resistor 31 is taken as the false signal indication signal SD (discussed below in detail), which signal is thereafter sent through the NOT gate 35 to the malfunction prevention circuit 4.

As seen from FIG. 2, the false signal detection circuit 3 has the same configuration as those of the on-level shift and off-level shift circuits of the level shift circuit 2, except that the HVMOS 32 is a dummy switching device. In the first preferred embodiment, the HVMOS 32 as the second switching device (second transistor) is equivalent to the HVMOS's 22a and 22b as the first switching devices (first transistors). That is, the parasitic diodes 23a, 23b and 33 are the same in electrical characteristic, and the parasitic capacitances 24a, 24b and 34 are the same in electrical characteristic.

Next, it will be discussed how a malfunction is prevented in the semiconductor device of the first preferred embodiment. First, it is assumed that a high-side reference potential VS experiences a negative noise at a high level. As discussed in the description of the background art, recovery of the high-side reference potential VS is accompanied by a recovery current as a result of turn-off of the parasitic diodes 23a and 23b in the level shift circuit 2, thereby causing voltage drops in the level shift resistors 21a and 21b reaching respective threshold values of the NOT gates 25a and 25b. As a result, a false signal is outputted from the level shift circuit 2.

The false signal detection circuit 3 is connected in parallel to the level shift circuit 2, and has the same configuration as those of the on-level shift and off-level shift circuits constituting the level shift circuit 2. Accordingly, recovery of the high-side reference potential VS from the negative noise also causes a recovery current to flow into the parasitic diode 33 of the HVMOS 32 as well as in the parasitic diodes 23a and 23b. The recovery current in the false signal detection circuit 3 passes through the false signal detecting resistor 31. The false signal detecting resistor 31 hence experiences voltage drop which temporally coincides with generation of the false signal at the level shift circuit 2. That is, voltage drop in the false signal detecting resistor 31 is operative to function as the false signal indication signal SD indicating false signal generation. The false signal indication signal SD is sent through the NOT gate 35 to the malfunction prevention circuit 4.

It is also assumed that the parasitic capacitances 24a and 24b of the HVMOS's 22a and 22b in the level shift circuit 2 are subjected to flow of a current as a result of a change in voltage dv/dt applied to the midpoint of the half bridge connection, which current will be referred to as a “current dv/dt”. When the current dv/dt causes voltage drops in the level shift resistors 21a and 21b, reaching the respective threshold values of the NOT gates 25a and 25b, a false signal is outputted from the level shift circuit 2.

As discussed, the false signal detection circuit 3 is connected in parallel to the level shift circuit 2, and has the same configuration as those of the on-level shift and off-level shift circuits constituting the level shift circuit 2. Accordingly, the parasitic capacitance 34 is also subjected to flow of the current dv/dt concurrently with flow of the current dv/dt in the parasitic capacitances 24a and 24b. The current dv/dt in the false signal detection circuit 3 passes through the false signal detecting resistor 31. Accordingly, the false signal detecting resistor 31 also experiences voltage drop which temporally coincides with generation of the false signal at the level shift circuit 2. That is, the false signal indication signal SD is also outputted in the case of generation of the false signal resulting from the current dv/dt.

As discussed, the false signal indication signal SD outputted from the false signal detection circuit 3 is indicative of generation of both the false signal in the level shift circuit 2 resulting from the recovery current flowing in the parasitic diodes, and the false signal resulting from the current dv/dt.

When the false signal indication signal SD is sent from the false signal detection circuit 3, the malfunction prevention circuit 4 recognizes the signal sent from the level shift circuit 2 as a false signal, and stops transmission thereof to the drive circuit 5. As a result, the power semiconductor element 100 is protected from malfunction.

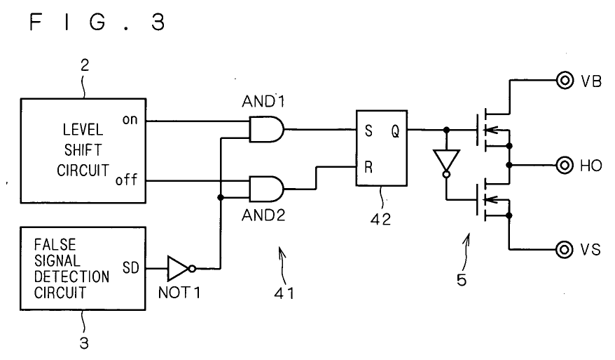

In the first preferred embodiment, the malfunction prevention circuit 4 comprises a logic portion 41 and an RS flip-flop 42. FIG. 3 shows an exemplary configuration of the malfunction prevention circuit 4. In the first preferred embodiment, three logic gates including AND gates 1 and 2, and a NOT gate 1 constitute the logic portion 41 of the malfunction prevention circuit 4. The on pulse signal from the level shift circuit 2 is sent to one input terminal of the AND gate 1, whereas the off pulse signal from the level shift circuit 2 is sent to one input terminal of the AND gate 2. The false signal indication signal SD from the false signal detection circuit 3 is sent through the NOT gate 1 to another input terminal of the AND gate 1, and to another input terminal of the AND gate 2. The output of the AND gate 1 is sent to the S input of the RS flip-flop 42, whereas the output of the AND gate 2 is sent to the R input of the RS flip-flop 42. The output of the RS flip-flop 42 is sent to the drive circuit 5.

When the level shift circuit 2 is in the normal operation experiencing no generation of a false signal, no input of the false signal indication signal SD occurs from the false signal detection circuit 3 (the false signal indication signal SD is placed at a low level). The on and off pulse signals transmitted to the logic portion 41 are hence directly sent to the S and R inputs of the RS flip-flop 42, respectively, thereafter entering the drive circuit 5 through the RS flip-flop 42.

When the false signal is generated in the level shift circuit 2 as a result of the recovery current flowing through the parasitic diodes 23a and 23b, or the current dv/dt flowing through the parasitic capacitances 24a and 24b, the false signal indication signal SD is sent to the logic portion 41 (the false signal indication signal SD is placed at a high level) concurrently with generation of the false signal. When the false signal indication signal SD is at a high level, the signal sent from the level shift circuit 2 (false signal) is subjected to masking at the AND gates 1 and 2, and hence, is not transmitted to the RS flip-flop 42. Malfunction resulting from the false signal generated in the level shift circuit 2 is thereby prevented.

The circuit configuration of the malfunction prevention circuit 4 shown in FIG. 3 is merely an example. As long as the malfunction prevention circuit 4 is operative to mask the signal sent from the level shift circuit 2 while being subjected to the input of the false signal indication signal SD, an alternative configuration is applicable.

In the first preferred embodiment, detection sensitivity of the false signal at the false signal detection circuit 3 can be easily controlled by adjusting the impedance of the false signal detecting resistor 31 or the threshold value of the NOT gate 35. As an example, false signal generation differs in time between the on-level shift and off-level shift circuits due to different values of the parasitic capacitances 24a and 24b, enhanced detection sensitivity of the false signal at the false signal detection circuit 3 serves to compensate for such a time lag. Design change of a circuit confirmation may be responsible for enhancement in detection sensitivity of the false signal such as increase in impedance of the false signal detecting resistor 31 or increase in threshold value of the NOT gate 35. At this time, each constituent element of the level shift circuit 2 is not required to be subjected to design change, whereby the detection sensitivity of the false signal is controlled while causing no effect on the normal operation of the level shift circuit 2. As a result, false signal elimination with a high degree of precision is allowed with no degeneration in reliability of the normal operation of the semiconductor device.

### Second Preferred Embodiment

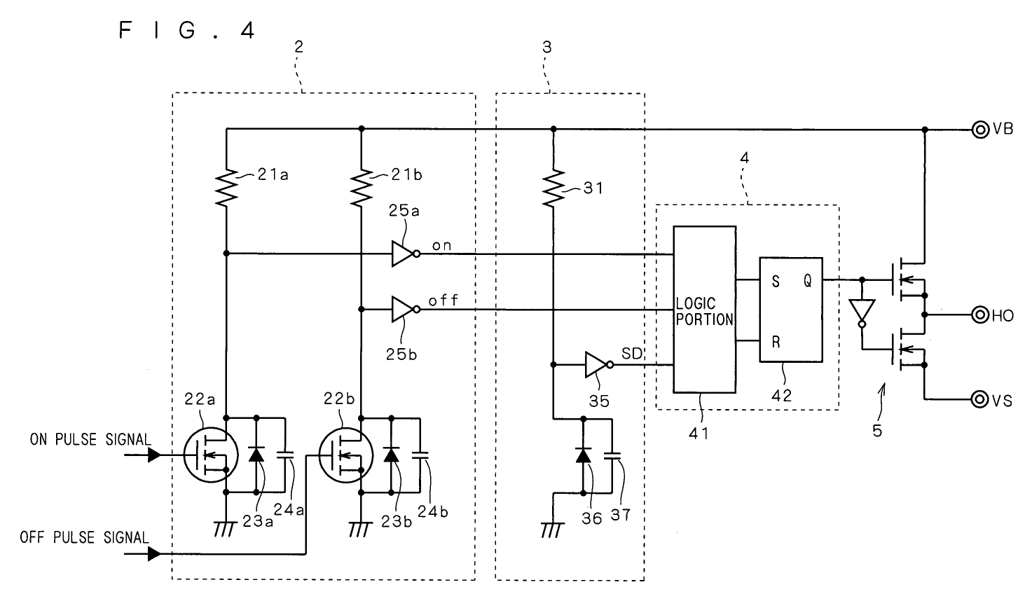

In a semiconductor device according to a second preferred embodiment of the present invention, the configuration shown in FIG. 4 is responsible for the process in an HVIC from the input to a level shift circuit to the output from a high side. The second preferred embodiment only differs in the configuration of the false signal detection circuit 3 from the first preferred embodiment. The configurations of the other elements and the operation of the semiconductor device as a whole are the same as those of the first preferred embodiment and hence, the description thereof will be omitted.

With reference to FIG. 4, the false signal detection circuit 3 of the second preferred embodiment includes a diode 36 as the second switching device connected in series to the false signal detecting resistor 31. The diode 36 and a capacitor 37 are connected in parallel. The diode 36 has an anode connected to the ground potential GND, and a cathode connected through the false signal detecting resistor 31 to the high-side power supply potential VB. That is, the diode 36 is fixed to an off state in the normal operation. Like in the first preferred embodiment, voltage drop developed in the false signal detecting resistor 31 is taken as the false signal indication signal SD, which signal is thereafter sent through the NOT gate 35 to the malfunction prevention circuit 4.

The diode 36 is the same in electrical characteristic as the parasitic diodes 23a and 23b. The capacitor 37 is the same in electrical characteristic as the parasitic capacitances 24a and 24b. Accordingly, the false signal detection circuit 3 of the second preferred embodiment outputs the false signal indication signal SD which is operative in the same manner as the one in the first preferred embodiment, namely, the false signal indication signal SD indicative of generation of both the false signal in the level shift circuit 2 resulting from the recovery current flowing in the parasitic diodes, and the false signal resulting from the current dv/dt flowing in the parasitic capacitances.

As discussed, the second preferred embodiment realizes malfunction prevention in the same manner as in the first preferred embodiment, thereby producing the same effect. The second preferred embodiment characteristically replaces the HVMOS 32 required in the first preferred embodiment with the diode 36 and the capacitor 37, thus providing enhanced flexibility in circuit design. Still advantageously, circuit design in the second preferred embodiment allows the capacitor 37 to be independently modified in value, whereby the detection sensitivity at the false signal detection circuit 3 can be controlled with a higher degree of ease.

### Third Preferred Embodiment

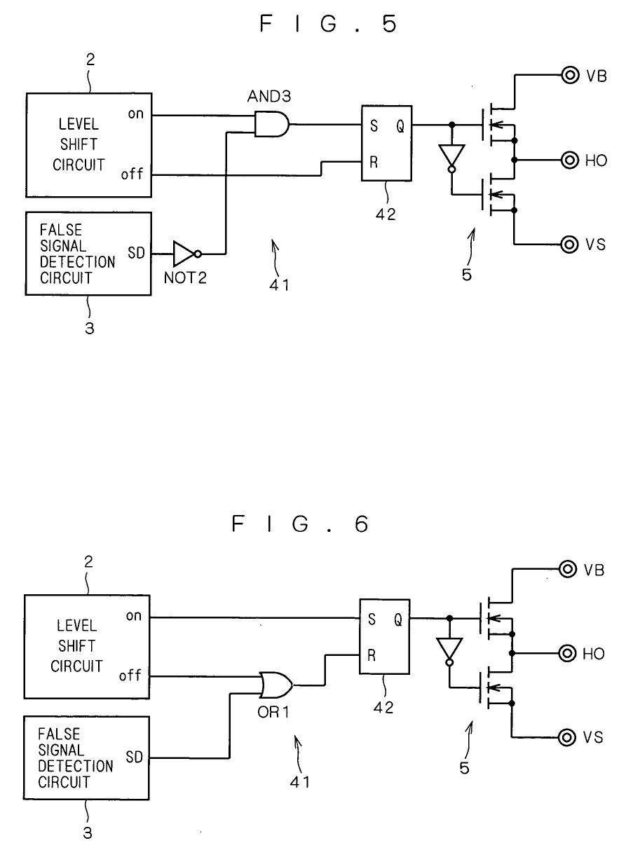

FIG. 5 shows the configuration of the malfunction prevention circuit 4 according to a third preferred embodiment of the present invention. With reference to FIG. 5, logic gates including an AND gate 3 and a NOT gate 2 constitute the logic portion 41 of the malfunction prevention circuit 4. The on pulse signal from the level shift circuit 2 is sent to one input terminal of the AND gate 3, whereas the off pulse signal from the level shift circuit 2 is directly sent to the R input of the RS flip-flop 42. The false signal indication signal SD from the false signal detection circuit 3 is sent through the NOT gate 2 to another input terminal of the AND gate 3. The output of the AND gate 3 is sent to the S input of the RS flip-flop 42.

When the level shift circuit 2 is in the normal operation experiencing no generation of a false signal, no input of the false signal indication signal SD occurs from the false signal detection circuit 3 (the false signal indication signal SD is placed at a low level). The on and off pulse signals transmitted to the logic portion 41 are hence directly sent to the S and R inputs of the RS flip-flop 42, respectively, thereafter entering the drive circuit 5 through the RS flip-flop 42.

When the false signal indication signal SD is sent to the logic portion 41 (the false signal indication signal SD is placed at a high level), the on pulse signal transmitted from the level shift circuit 2 is subjected to masking at the AND gate 3, and hence, is not sent to the RS flip-flop 42. Accordingly, a false signal does not cause the power semiconductor element 100 to be turned on by means of the drive circuit 5, while it may cause the power semiconductor element 100 to be turned off.

As an example, a device such as a single-phase half bridge driver only requires that “no short circuit occurs” as a minimum requirement for malfunction prevention. The third preferred embodiment applied to such a device realizes malfunction prevention.

As seen from the comparison with FIG. 3 of the first preferred embodiment, the malfunction prevention circuit 4 of the third preferred embodiment eliminates a circuit (the AND gate 2 shown in FIG. 3) for removing a false signal generated in the off level shift circuit, which circuit is not necessarily a precondition in the device only requiring that “no short circuit occurs”. The third preferred embodiment hence realizes a lower parts count than the first preferred embodiment, resulting in cost reduction.

The circuit configuration of the malfunction prevention circuit 4 shown in FIG. 5 is merely an example. As long as the malfunction prevention circuit 4 is operative to mask the signal sent from the level shift circuit 2 while being subjected to the input of the false signal indication signal SD, an alternative configuration is applicable.

### Fourth Preferred Embodiment

FIG. 6 shows the configuration of the malfunction prevention circuit 4 according to a fourth preferred embodiment of the present invention. With reference to FIG. 6, only a single logic gate, namely, an OR gate 1 constitutes the logic portion 41 of the malfunction prevention circuit 4. The on pulse signal from the level shift circuit 2 is directly sent to the S input of the RS flip-flop 42. The off pulse signal from the level shift circuit 2 and the false signal indication signal SD from the false signal detection circuit 3 are sent to the OR gate 1. The output of the OR gate 1 is sent to the R input of the RS flip-flop 42.

When the level shift circuit 2 is in the normal operation experiencing no generation of a false signal, no input of the false signal indication signal SD occurs from the false signal detection circuit 3 (the false signal indication signal SD is placed at a low level). The on and off pulse signals transmitted to the logic portion 41 are hence directly sent to the S and R inputs of the RS flip-flop 42, respectively, thereafter entering the drive circuit 5 through the RS flip-flop 42.

When the false signal indication signal SD is sent to the logic portion 41 (the false signal indication signal SD is placed at a high level), the false signal indication signal SD is sent as the off pulse signal to the RS flip-flop 42. Accordingly, generation of a false signal necessarily brings the power semiconductor element 100 to an off state (nonconductive state) by means of the drive circuit 5.

The fourth preferred embodiment also realizes malfunction prevention when applied to a device only requiring that “no short circuit occurs”. As seen from the comparison with FIG. 3 of the first preferred embodiment, the fourth preferred embodiment realizes a lower parts count than the first preferred embodiment, resulting in cost reduction.

The circuit configuration of the malfunction prevention circuit 4 shown in FIG. 6 is merely an example. As long as the malfunction prevention circuit 4 is operative to transmit the off pulse signal to the RS flip-flop 42 while being subjected to the input of the false signal indication signal SD, an alternative configuration is applicable.

### Fifth Preferred Embodiment

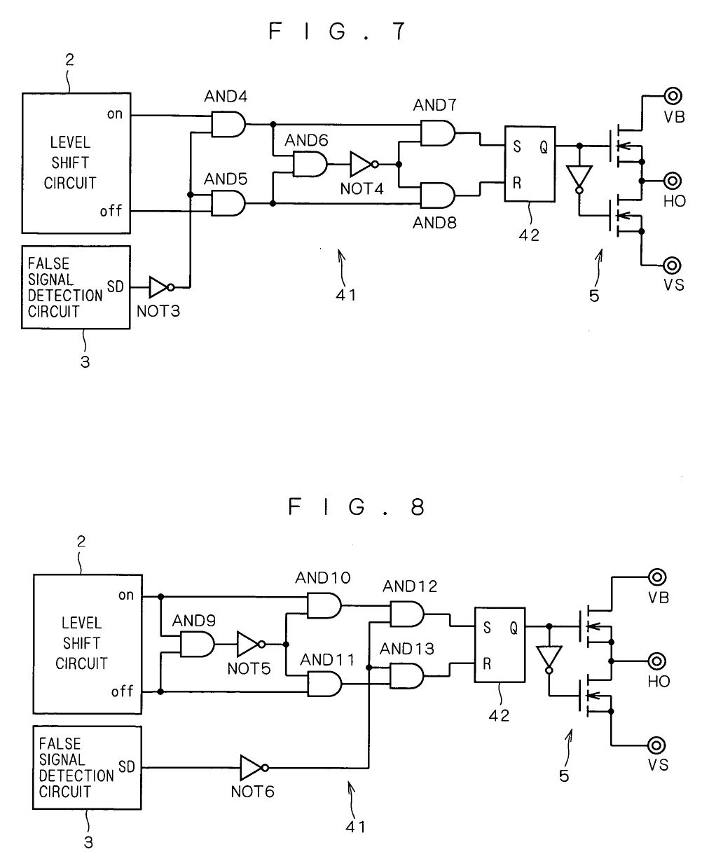

FIG. 7 shows the configuration of the malfunction prevention circuit according to a fifth preferred embodiment of the present invention. The fifth preferred embodiment is a combination of the present invention and the logic filter system introduced in Japanese Patent Application Laid-Open No. 2001-145370 discussed above.

With reference to FIG. 7, logic gates including AND gates 4, 5, 6, 7 and 8, and NOT gates 3 and 4 constitute the logic portion 41 of the malfunction prevention circuit 4. The on pulse signal from the level shift circuit 2 is sent to one input terminal of the AND gate 4, whereas the off pulse signal from the level shift circuit 2 is sent to one input terminal of the AND gate 5. The false signal indication signal SD from the false signal detection circuit 3 is sent through the NOT gate 3 to another input terminal of the AND gate 4 and to another input terminal of the AND gate 5. The AND gate 6 receives the respective outputs of the AND gates 4 and 5. The AND gate 7 receives the output of the AND gate 4, and the output of the AND gate 6 after passing through the NOT gate 4. The output of the AND gate 7 is sent to the S input of the RS flip-flop 42. The AND gate 8 receives the output of the AND gate 5, and the output of the AND gate 6 after passing through the NOT gate 4. The output of the AND gate 8 is sent to the R input of the RS flip-flop 42.

When the level shift circuit 2 is in the normal operation experiencing no generation of a false signal, no input of the false signal indication signal SD occurs from the false signal detection circuit 3 (the false signal indication signal SD is placed at a low level). The on and off pulse signals transmitted to the logic portion 41 are hence directly sent to the S and R inputs of the RS flip-flop 42, respectively, thereafter entering the drive circuit 5 through the RS flip-flop 42. When the on and off pulse signals are concurrently sent to the logic portion 41, a logic filter formed by the AND gates 6, 7, 8 and the NOT gate 4 becomes operative to recognize these pulse signals as false signals, to thereby stop transmission of these signals to the RS flip-flop 42. As a result, false signals concurrently generated in the on-level shift and off-level shift circuits do not cause a malfunction.

When the false signal indication signal SD is sent to the logic portion 41 (the false signal indication signal SD is placed at a high level), the signal sent from the level shift circuit 2 (false signal) is subjected to masking at the AND gates 4 and 5 and hence, is not sent to the foregoing logic filter. A malfunction resulting from the false signal generated in the level shift circuit 2 is thereby prevented.

As discussed, the present invention combined with the logic filter system allows malfunction prevention with a higher degree of reliability.

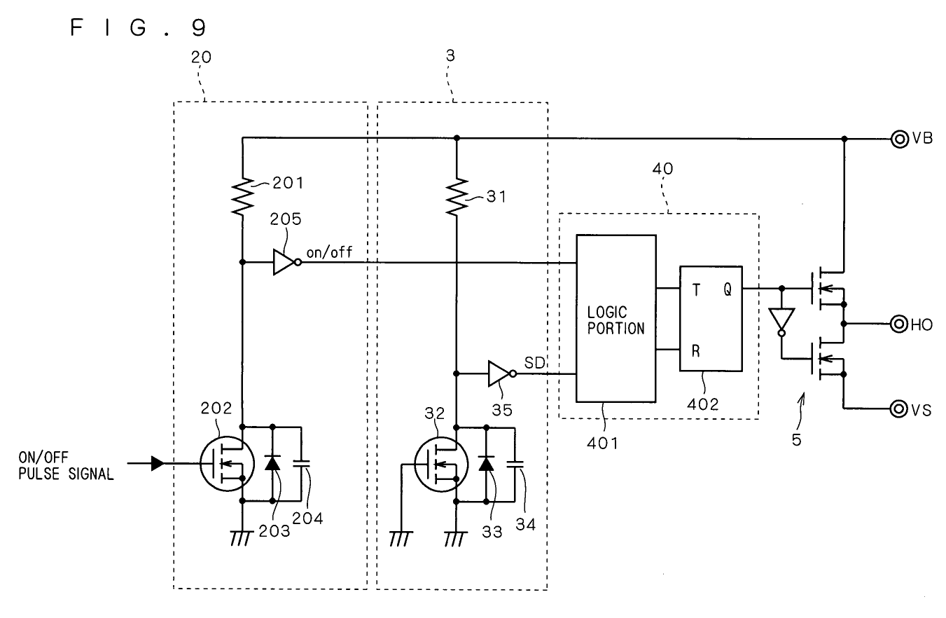

In the configuration shown in FIG. 7, the input stage of the logic filter (including the AND gates 6, 7, 8 and the NOT gate 4) is provided with the circuit of the present invention (including the AND gates 4, 5 and the NOT gate 3) operative to mask the signal from the level shift circuit 2 while being subjected to the input of the false signal indication signal SD. However, the logic portion 41 of the fifth preferred embodiment may have an alternative circuit configuration. With reference to FIG. 8, the output stage of a logic filter (including AND gates 9, 10, 11 and a NOT gate 5) may be provided with the circuit of the present invention (including AND gates 12, 13 and a NOT gate 6) operative to mask the signal from the logic filter while being subjected to the input of the false signal indication signal SD. Such an alternative circuit configuration also allows malfunction prevention with a higher degree of reliability by means of a combination of the present invention and the logic filter serving for removal of a false signal.

### Sixth Preferred Embodiment

In the foregoing preferred embodiments, the level shift circuit 2 has been described as a combination of two level shift circuits for respectively handle the on and off pulse signals. In general, the on and off pulses are alternately sent. In view of this, a single level shift circuit receiving a pulse signal including both the on and off pulses also serves to actuate the high side of the HVIC by recognizing odd-numbered pulses as the on pulses, and even-numbered pulses as the off pulses, for example.

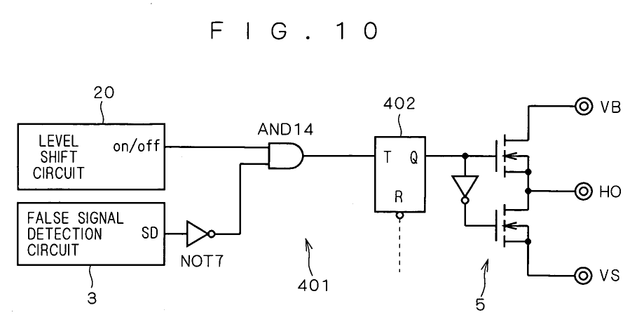

FIG. 9 shows a semiconductor device according to a sixth preferred embodiment of the present invention. In the semiconductor device shown in FIG. 1, the configuration of FIG. 9 is responsible for the process in the HVIC from the input to the level shift circuit to the output from the high side. A level shift circuit 20 of the sixth preferred embodiment receives a pulse signal including both the on and off pulses (hereinafter referred to as an “on/off pulse signal”). That is, the on and off pulses are alternately sent to the level shift circuit 20.

The level shift circuit 20 is formed by a single level shift circuit. That is, the level shift circuit 20 includes a series connection of a level shift resistor 201 and an HVMOS 202 as the first switching device, and a NOT gate 205 connected to one end of the level shift resistor 201. Reference numerals 203 and 204 in FIG. 9 respectively represent a parasitic diode and a parasitic capacitance inherent in the HVMOS 202. The HVMOS 202 has a gate receiving the on/off pulse signal, a source connected to the ground potential GND, and a drain connected through the level shift resistor 201 to the high-side power supply potential VB. The HVMOS 202 is switched on and off in response to the on/off pulse signal (first signal). Voltage drop thereby developed in the level shift resistor 201 is taken as an on/off signal for the high side (second signal), which signal is thereafter sent through the NOT gate 205 as a buffer to the malfunction prevention circuit 4.

The false signal detection circuit 3 in the sixth preferred embodiment has the same configuration as that of the first preferred embodiment, and hence, the description thereof is omitted. As seen from FIG. 9, the false signal detection circuit 3 has the same configuration as that of the level shift circuit 20, except that the HVMOS 32 is a dummy switching device. The HVMOS 32 of the sixth preferred embodiment as the second switching device (second transistor) is also equivalent to the HVMOS 202 as the first switching device (first transistor). That is, the parasitic diodes 33 and 203 are the same in electrical characteristic, and the parasitic capacitances 34 and 204 are the same in electrical characteristic.

As a result, the false signal indication signal SD outputted from the false signal detection circuit 3 is indicative of generation of both the false signal in the level shift circuit 20 resulting from the recovery current flowing in the parasitic diode, and the false signal resulting from the current dv/dt.

The malfunction prevention circuit 40 receiving the false signal indication signal SD recognizes the signal sent from the level shift circuit 20 as a false signal while being subjected to the input of the false signal indication signal SD from the false signal detection circuit 3, and stops transmission thereof to the drive circuit 5. The power semiconductor element 100 is hence protected from malfunction. In the sixth preferred embodiment, the malfunction prevention circuit 40 comprises a logic portion 401, and a T flip-flop 402 operative to serve as a frequency divider.

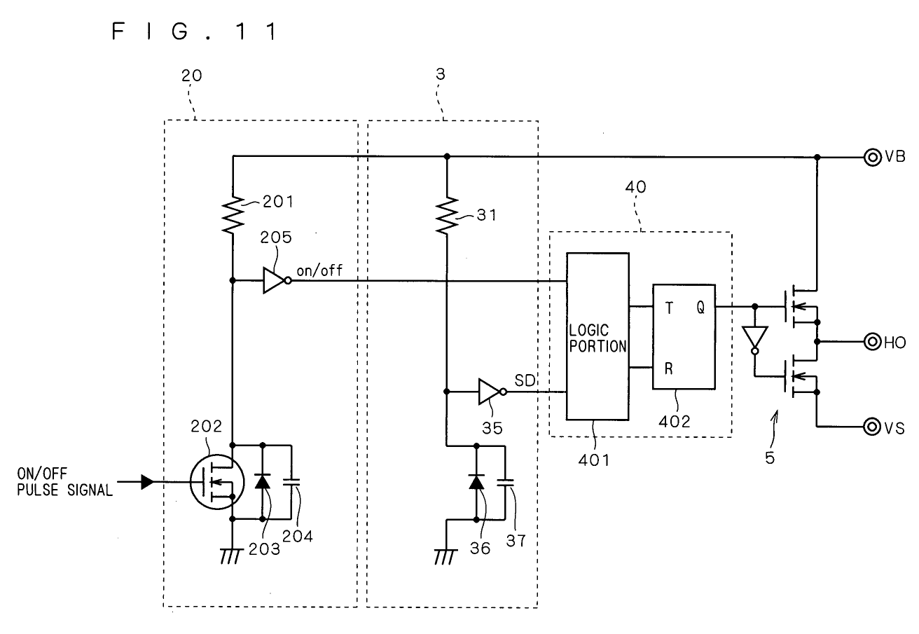

FIG. 10 shows an exemplary configuration of the malfunction prevention circuit 40. In the sixth preferred embodiment, logic gates including an AND gate 14 and a NOT gate 7 constitute the logic portion 401 of the malfunction prevention circuit 40. The on/off pulse signal from the level shift circuit 20 is sent to one input terminal of the AND gate 14. The false signal indication signal SD is sent through the NOT gate 7 to another input terminal of the AND gate 14. The output of the AND gate 14 is sent to the T input of the T flip-flop 402. Each time the on/off pulse signal is received, the T flip-flop 402 serves to invert the output (that is, the T flip-flop 402 divides the frequency at the input by two), to thereby transmit a signal to the drive circuit 5 in response to the on/off pulse signal.

When the level shift circuit 20 is in the normal operation experiencing no generation of a false signal, no input of the false signal indication signal SD occurs from the false signal detection circuit 3 (the false signal indication signal SD is placed at a low level). The on/off pulse signal transmitted to the logic portion 401 is hence directly sent to the T flip-flop 402, thereafter entering the drive circuit 5 through the T flip-flop 402.

When the false signal indication signal SD is sent to the logic portion 401 (the false signal indication signal SD is placed at a high level), the signal sent from the level shift circuit 20 (false signal) is subjected to masking at the AND gate 14, and is not sent to the T flip-flop 402. A malfunction resulting from the false signal generated in the level shift circuit 20 is thereby prevented.

As discussed, the logic filter system introduced in Japanese Patent Application Laid-Open No. 2001-145370 is not applicable to the case in which a single level shift circuit is used to transmit a pulse signal including both the on and off pulses, whereas the present invention can be applied to such a case. As seen from the comparison between FIGS. 2 and 10, a single level shift circuit serving to transmit a pulse signal including both the on and off pulses provides a simpler circuit configuration. The sixth preferred embodiment hence realizes scaledown of a circuit configuration and cost reduction.

The circuit configuration of the malfunction prevention circuit 40 shown in FIG. 10 is merely an example. As long as the malfunction prevention circuit 40 is operative to mask the signal sent from the level shift circuit 20 while being subjected to the input of the false signal indication signal SD, an alternative configuration is applicable.

### Seventh Preferred Embodiment

FIG. 11 show the configuration of a semiconductor device according to a seventh preferred embodiment of the present invention, and more particularly, shows the configuration responsible for the process in an HVIC from the input to a level shift circuit to the output from a high side. The seventh preferred embodiment is a combination of the sixth preferred embodiment and the false signal detection circuit 3 according to the second preferred embodiment (FIG. 4). More particularly, the false signal detection circuit 3 includes the diode 36 as the second switching device connected in series to the false signal detecting resistor 31. The diode 36 and the capacitor 37 are connected in parallel. The diode 36 and the parasitic diode 203 of the HVMOS 202 are the same in electrical characteristic, and the capacitor 37 and the parasitic capacitance 204 are the same in electrical characteristic.

Accordingly, the false signal indication signal SD outputted from the false signal detection circuit 3 is indicative of generation of both the false signal in the level shift circuit 20 resulting from the recovery current flowing in the parasitic diode, and the false signal resulting from the current dv/dt.

The seventh preferred embodiment is hence operative in the same manner for malfunction prevention as the sixth preferred embodiment, to thereby produce the same effect. The seventh preferred embodiment characteristically replaces the HVMOS 32 required in the sixth preferred embodiment with the diode 36 and the capacitor 37, thus providing enhanced flexibility in circuit design. Still advantageously, circuit design in the seventh preferred embodiment allows the capacitor 37 to be independently modified in value, whereby the detection sensitivity at the false signal detection circuit 3 can be controlled with a higher degree of ease.

While the invention has been shown and described in detail, the foregoing description is in all aspects illustrative and not restrictive. It is therefore understood that numerous modifications and variations can be devised without departing from the scope of the invention.

1. A semiconductor device, comprising:
a level shift circuit for converting a first signal to a second signal capable of being transmitted to a target circuit in a high side;
a false signal detection circuit for detecting generation of a false signal in said level shift circuit, to output a false signal indication signal indicating generation of said false signal; and
a malfunction prevention circuit receiving said second signal and said false signal indication signal, said malfunction prevention circuit serving to transmit said second signal to said target circuit, said malfunction prevention circuit further serving to recognize said second signal as a false signal to stop transmission of at least part of said second signal to said target circuit while being subjected to the input of said false signal indication signal, to thereby prevent a malfunction,
wherein said level shift circuit includes a series connection of a first resistor and a first switching device receiving said first signal, said level shift circuit outputting voltage drop developed in said first resistor as said second signal,
wherein said false signal detection circuit is connected in parallel to said level shift circuit, and
wherein said false signal detection circuit includes a series connection of a second resistor and a second switching device fixed to a nonconductive state in normal operation, said false signal detection circuit outputting voltage drop developed in said second resistor as said false signal indication signal.

2. The semiconductor device according to claim 1,
wherein said second switching device has a diode element and a capacitive element equivalent to those of said first switching device.

3. The semiconductor device according to claim 1,
wherein said first switching device is a first transistor, and
wherein said second switching device is a second transistor.

4. The semiconductor device according to claim 3,
wherein said second transistor has a parasitic diode and a parasitic capacitance equivalent to those of said first transistor.

5. The semiconductor device according to claim 1,
wherein said second switching device is a diode connected in parallel to a capacitor.

6. The semiconductor device according to claim 5,
wherein said capacitor is the same in electrical characteristic as a parasitic capacitance of said first switching device, and
wherein said diode is the same in electrical characteristic as a parasitic diode of said first switching device.

7. The semiconductor device according to claim 1,
wherein said malfunction prevention circuit performs masking on said second signal while being subjected to the input of said false signal indication signal, to output a resultant signal to said target circuit.

8. The semiconductor device according to claim 1,
wherein said target circuit is a drive circuit for actuating a third switching device, and
wherein said malfunction prevention circuit performs masking on a signal as part of said second signal while being subjected to the input of said false signal indication signal, said signal as part of said second signal causing said third switching device to be turned on, to output a resultant signal to said target circuit.

9. The semiconductor device according to claim 1,
wherein said target circuit is a drive circuit for actuating a third switching device, and
wherein said malfunction prevention circuit outputs a signal to said target circuit while being subjected to the input of said false signal indication signal, said signal to said target circuit bringing said third switching device to a nonconductive state.
